(19) United States
(12) Patent Application Publication
(10) Pub. No.: US 2026/0364656 A1
(43) Pub. Date: Nov. 19, 2026

(54) TWO-ROLL ROLLING APPARATUS FOR ULTRASONIC-ASSISTED LONGITUDINAL-TORSIONAL COMPOSITE VIBRATION

(71) Applicant: Taiyuan University of Technology, Taiyuan City (CN)

(72) Inventors: Zhongkai REN, Taiyuan City (CN); Xiaohua HU, Taiyuan City (CN); Jinyu ZHAO, Taiyuan City (CN); Jing WANG, Taiyuan City (CN); Jiazhao CHEN, Taiyuan City (CN); Jianghong WANG, Taiyuan City (CN)

(21) Appl. No.: 19/395,315

(22) Filed: Nov. 20, 2025

(30) Foreign Application Priority Data
May 16, 2025 (CN) 202510630214.5

(51) Int. Cl. B21B 1/24; B21B 35/00

(52) U.S. Cl. CPC B21B 1/24; B21B 35/00

(57) ABSTRACT

A two-roll rolling apparatus for ultrasonic-assisted longitudinal-torsional composite vibration is provided. The apparatus includes a rolling mill frame, an ultrasonic longitudinal-torsional vibration device, a winding device, an auxiliary winding device, and an unwinding device. The ultrasonic longitudinal-torsional vibration device includes a horn roll shaft, a connecting shaft, piezoelectric ceramics, copper electrodes, a rear cover plate, and hexagon socket head bolts, and has two forms: a single-excitation form and a dual-excitation form. The single-excitation device adopts a quarter-wavelength conical horn, the conical surface of the horn is provided with spiral grooves that may convert part of the longitudinal vibration into torsional vibration. The dual-excitation device synergistically increases the torsional vibration amplitude through two symmetrically arranged longitudinal-torsional horns.

### CROSS-REFERENCE TO RELATED APPLICATIONS

This application claims priority to Chinese Patent Application No. 202510630214.5, filed on May 16, 2025, the contents of which are hereby incorporated by reference.

### TECHNICAL FIELD

The present disclosure relates to the technical field of ultra-thin strip rolling, and particularly relates to a two-roll rolling apparatus for ultrasonic-assisted longitudinal-torsional composite vibration.

### BACKGROUND

High-precision ultra-thin strips are widely used in aerospace, military and nuclear power, high-end electronics, automobiles, home appliances, medical treatment, and petrochemical industries. Thin strips of 0.05-0.1 millimeters may be used for keypads of electronic components. Thin strips of 0.1-0.6 millimeters are widely used for polished mirror-like products. Thin strips of 0.02-0.2 millimeters are widely used for metal diaphragm materials. Thin strips of 0.02-0.5 millimeters are used for universal serial bus interface (USB) interface materials. Thin strips of 0.12 millimeters may be used for diamond blades. Thin strips of 0.2 millimeters may be used as base materials for medical needles. These cutting-edge fields impose higher requirements on the strength, surface roughness, geometric accuracy, fatigue resistance, and other properties of the required materials.

Currently, the production of high-precision ultra-thin strips still faces many problems, such as large and unevenly distributed residual stress, high surface roughness with obvious texture, and large average grain size. Conventional rolling control methods for precision thin strips are difficult to solve the aforementioned problems. Therefore, exploring a novel rolling control process is of great significance. Research shows that the “volume effect” and “surface effect” generated by the ultrasonic vibration energy field during plastic forming may change the material's microstructure, thereby reducing deformation resistance, effectively mitigating work hardening phenomena, and improving the plastic deformation capability of metals. Furthermore, the high-frequency vibration energy generated by ultrasonic vibration promotes tangential deformation of the surface asperities of the workpiece, reduces obstacles to metal sliding, and lowers the surface roughness value. Simultaneously, applying ultrasonic vibration to the deformed metal may promote the migration and proliferation of dislocations within the crystal, thereby achieving grain refinement.

In view of this, it is necessary to provide a two-roll rolling apparatus for ultrasonic-assisted longitudinal-torsional composite vibration to solve problems such as high surface roughness, large residual stress, and large grain size that occur during the rolling of existing thin strips.

### SUMMARY

The purpose of the present disclosure is to provide a two-roll rolling apparatus for ultrasonic-assisted longitudinal-torsional composite vibration. By constructing an ultrasonic longitudinal-torsional composite vibration field in the roll-strip system, the apparatus aims to effectively solve problems encountered in the conventional ultra-thin strip rolling process.

To achieve the above purpose, the present disclosure provides the following solution: a two-roll rolling apparatus for ultrasonic-assisted longitudinal-torsional composite vibration, including:
a rolling mill frame mounted on a rolling mill body;
an ultrasonic longitudinal-torsional vibration device installed inside the rolling mill frame, for connecting an ultrasonic generating device and a roll shaft of a rolling mill; where the ultrasonic longitudinal-torsional vibration device includes a horn roll shaft, a connecting shaft, piezoelectric ceramics, copper electrodes, a rear cover plate, and a hexagon socket head bolt; where the horn roll shaft has a stepped shaft at one end and is connected to a longitudinal-torsional horn at another end, the longitudinal-torsional horn is a conical horn, a conical surface of the longitudinal-torsional horn is provided with spiral grooves, a length of the spiral grooves is equal to a length of the conical surface, and a spiral direction of the spiral grooves is the same as a rotation direction of the horn roll shaft; and
a winding device, an auxiliary winding device, and an unwinding device arranged on two sides of the rolling mill, for providing a strip to be rolled, guiding transmission of the strip, and coiling a rolled strip into a coil.

In an embodiment, the connecting shaft is a stepped shaft, one end of the connecting shaft is threadedly connected to the longitudinal-torsional horn, another end of the connecting shaft is coaxially assembled with the alternately stacked piezoelectric ceramics and the copper electrodes, and the connecting shaft is pre-fastened with the rear cover plate by the hexagon socket head bolts.

In an embodiment, a number of the piezoelectric ceramics is even, longitudinal polarization directions of every two adjacent of the piezoelectric ceramics are opposite, and the piezoelectric ceramics are bonded by an adhesive to form a piezoelectric ceramic stack.

In an embodiment, the ultrasonic longitudinal-torsional vibration device is a single-excitation ultrasonic longitudinal-torsional vibration device or a dual-excitation ultrasonic longitudinal-torsional vibration device.

In an embodiment, the single-excitation ultrasonic longitudinal-torsional vibration device includes a single horn roll shaft, where the single horn roll shaft is designed as the stepped shaft at one end and as the longitudinal-torsional horn at another end; and the longitudinal-torsional horn is a quarter-wavelength horn, and an input end area of the longitudinal-torsional horn is larger than an output end area for achieving energy concentration.

In an embodiment, the dual-excitation ultrasonic longitudinal-torsional vibration device includes a dual horn roll shaft, where the dual horn roll shaft includes two longitudinal-torsional horns symmetrically arranged, the spiral grooves of the two longitudinal-torsional horns have opposite spiral directions, for cooperatively increasing a torsional vibration amplitude.

In an embodiment, a height h, a width b, and a spiral angle θ of the spiral grooves, and conical surface radii R and r are adjusted according to production requirements, for achieving different longitudinal-torsional vibration amplitudes.

In an embodiment, the spiral angle of the spiral grooves is 45 degrees, and a number of the spiral grooves is four, and the spiral grooves are uniformly provided along the conical surface.

In an embodiment, a pressing-down device is installed above the rolling mill frame, and a supporting mechanism is installed on a side surface of the rolling mill frame.

In an embodiment, the two-roll rolling apparatus for ultrasonic-assisted longitudinal-torsional composite vibration further includes a controller and an electrical cabinet provided on the rolling mill body, the controller is configured for tension control and parameter adjustment, and the electrical cabinet is configured to provide power supply.

The present disclosure has the following beneficial effects.

The present disclosure provides a two-roll rolling apparatus for ultrasonic-assisted longitudinal-torsional composite vibration. By combining the ultrasonic generating device with the rolling mill, longitudinal-torsional composite vibration rolling of high-precision ultra-thin strips is achieved. The “volume effect” and “surface effect” generated by the ultrasonic vibration energy field during plastic forming play significant roles.

The “volume effect” may cause a decrease in the flow stress inside the material, reduce the deformation resistance of the material, and improve the plastic deformation capability of the metal. Meanwhile, the acoustic softening effect in the “volume effect” may promote the deformation of surface asperities of the material, thereby improving the surface quality of the high-precision ultra-thin strip and improving the surface roughness.

The “surface effect” of the ultrasonic vibration energy field may cause periodic changes in the friction force between the roll and the high-precision ultra-thin strip, thereby reducing the sliding friction force between them. In addition, after severe plastic deformation occurs on the material surface, the ultrasonic vibration energy field may achieve grain refinement, and counteract or reduce the distribution of residual stress.

### BRIEF DESCRIPTION OF THE DRAWINGS

To more clearly illustrate the technical solutions in the embodiments of the present disclosure or the prior art, the drawings required for the embodiments will be briefly introduced below. Obviously, the drawings in the following description are only some embodiments of the present disclosure, and for those of ordinary skill in the art, other drawings may be obtained based on these drawings without creative effort.

FIG. 1 is a schematic structural diagram of the two-roll rolling apparatus for ultrasonic-assisted longitudinal-torsional composite vibration of the present disclosure.

FIG. 2 is a schematic structural diagram of a single-excitation ultrasonic longitudinal-torsional vibration device in the apparatus of the present disclosure.

FIG. 3 is an exploded view of the single-excitation ultrasonic longitudinal-torsional vibration device in the apparatus of the present disclosure.

FIG. 4 is an axial cross-sectional view of the single-excitation ultrasonic longitudinal-torsional vibration device during assembly in the apparatus of the present disclosure.

FIG. 5 is a schematic structural diagram of a dual-excitation ultrasonic longitudinal-torsional vibration device in the apparatus of the present disclosure.

FIG. 6 is an exploded view of the dual-excitation ultrasonic longitudinal-torsional vibration device in the apparatus of the present disclosure.

FIG. 7 is a structural diagram of spiral grooves of a conical horn in the apparatus of the present disclosure.

FIG. 8 is a cross-sectional view of the spiral grooves of the conical horn in the apparatus of the present disclosure.

### DETAILED DESCRIPTION OF THE EMBODIMENTS

The technical solutions in the embodiments of the present disclosure will be clearly and completely described below in conjunction with the accompanying drawings in the embodiments of the present disclosure. It is apparent that the described embodiments are only a part of the embodiments of the present disclosure, and not all of the embodiments. All other embodiments obtained by a person of ordinary skill in the art based on the embodiments of the present disclosure without creative efforts shall fall within the protection scope of the present disclosure.

To make the above purposes, features, and advantages of the present disclosure more clearly understood, the present disclosure is further described in detail below in conjunction with the accompanying drawings and specific implementations.

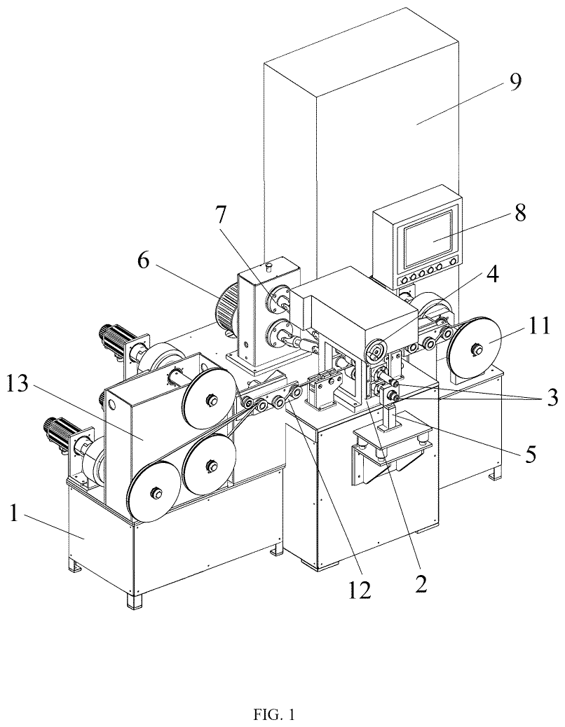

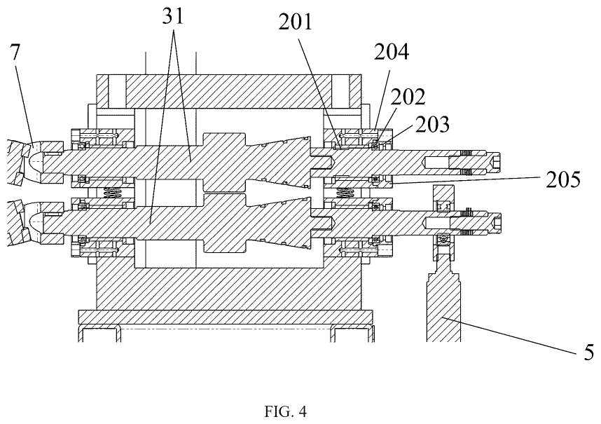

With reference to FIGS. 1 to 8, the present disclosure provides a two-roll rolling apparatus for ultrasonic-assisted longitudinal-torsional composite vibration. The apparatus includes a rolling mill disposed on a rolling mill body 1, an ultrasonic generating device, a rolling mill frame 2, an ultrasonic longitudinal-torsional vibration device 3, a rolling mill drive mechanism 6, a controller 8, and an electrical cabinet 9, as well as a winding device 11, an auxiliary winding device 12, and an unwinding device 13 rotatably mounted on the rolling mill body 1. The ultrasonic longitudinal-torsional vibration device 3 is installed inside the rolling mill frame 2. The ultrasonic longitudinal-torsional vibration device 3 is used to connect the ultrasonic generating device and a roll shaft of the rolling mill, achieving a combination of the ultrasonic generating device and the rolling mill. A pressing-down device 4 is installed above the rolling mill frame 2 for cooperatively adjusting the ultrasonic longitudinal-torsional vibration device 3, and a supporting mechanism 5 is installed on a side surface. The pressing-down device 4 is arranged above the rolling mill and is used to control the magnitude of the rolling pressure. The contact pressure between the roll 312 and the rolled material is adjusted to ensure that the force applied during the rolling process meets the rolling requirements of ultra-thin strips. The main function of the supporting mechanism 5 is to provide stable mechanical support for the roll 312 system. In the rolling process, the roll 312 needs to withstand a large rolling force and vibration loads. The supporting device ensures that the roll 312 maintains the correct position and posture during operation, preventing deformation or damage caused by uneven force or vibration. Because ultra-thin strips require extremely high thickness uniformity and surface quality, the supporting device may effectively reduce radial and axial runout of the roll 312, thereby improving rolling precision.

In the above embodiment, the rolling mill is the physical platform for the entire rolling process. It carries and fixes the roll 312 system and provides the necessary mechanical support and structural framework for the rolling process. The design of the rolling mill requires sufficient rigidity to withstand the high pressure and high-frequency vibrations generated during the rolling process. It should be understood that the rolling mill is equipped with various adjustment devices, such as the pressing-down device 4 and the supporting mechanism 5 in this embodiment, for precisely controlling parameters of the roll 312 such as the gap, rolling force, and rolling speed to meet the requirements of different rolling processes. These adjustment functions are crucial for producing high-quality ultra-thin strips.

In the above embodiment, the main function of the rolling mill drive mechanism 6 is to provide power for the rolling mill and to drive the rotation of the roll 312. The rolling mill drive mechanism 6 transmits the torque from the motor to the roll shaft through a universal coupling 7. The rolling mill drive mechanism 6 usually includes a motor, a reducer, and a transmission system, and it may transmit the rotational motion of the motor to the roll 312. The rolling mill drive mechanism 6 in this embodiment may adopt conventional drive devices from existing technology, which typically include efficient motors and transmission systems. During the ultrasonic longitudinal-torsional composite vibration rolling process, the drive mechanism needs to ensure stable transmission of torque while being compatible with the vibration characteristics of the ultrasonic generating device.

In the above embodiment, the controller 8 serves as the control system for the entire device. It is responsible for coordinating the operation of various components, controlling tension, adjusting parameters, and implementing fault monitoring and alarm functions to ensure the automation and intelligence of the rolling process. One of its main functions is to control the tension of the winding device 11 and the unwinding device 13, while coordinating the operation of the entire rolling system. The electrical cabinet 9 provides a stable power supply for the rolling mill drive device, the ultrasonic generating device, the controller 8, and other auxiliary equipment. It protects the equipment from the effects of power faults and provides driving and control functions for the motor and the ultrasonic generating device, ensuring the normal operation of the system. The controller 8 and the electrical cabinet 9 may employ mature techniques from existing technology, which are not elaborated here.

In the above embodiment, the winding device 11, the auxiliary winding device 12, and the unwinding device 13 are arranged on both sides of the rolling mill. The rolling centers of these three devices are required to be on the same horizontal centerline. The winding device 11 (such as a winder or a coiler) is the end point of the rolling process and the main function is to re-coil the rolled strip into a coil for subsequent processing or storage. The auxiliary winding device 12 (such as a tensioner) applies a certain pressure or tension to the strip, guides the accurate transmission of the strip, avoids deviation or jamming, and ensures the smooth progress of the rolling process. The unwinding device 13 (such as an unwinder or an uncoiler) smoothly unwinds the strip to be rolled from the coil, providing continuous raw material input for the rolling process.

The ultrasonic longitudinal-torsional vibration device 3 may adopt a single-excitation ultrasonic longitudinal-torsional vibration device 31, or it may adopt a dual-excitation ultrasonic longitudinal-torsional vibration device 32.

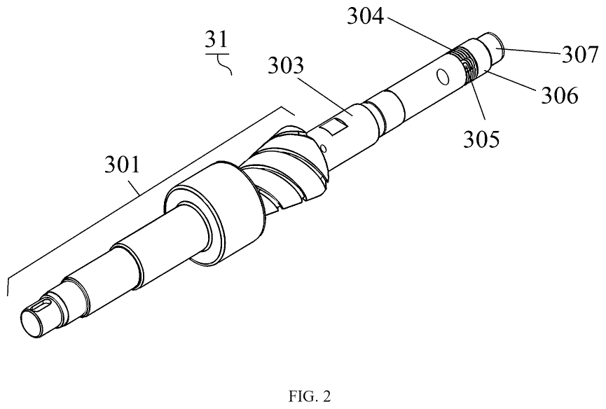

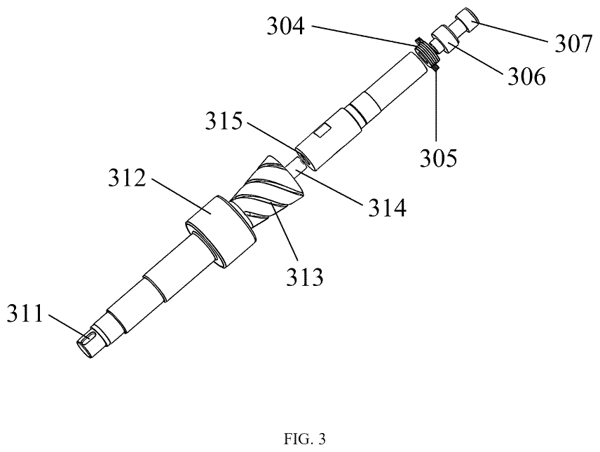

In a specific embodiment, the ultrasonic longitudinal-torsional vibration device 3 adopts a single-excitation ultrasonic longitudinal-torsional vibration device 31. As shown in FIG. 2 and FIG. 3, the single-excitation ultrasonic longitudinal-torsional vibration device 31 includes a single horn roll shaft 301, a connecting shaft 303, piezoelectric ceramics 304, copper electrodes 305, a rear cover plate 306, and a hexagon socket head bolt 307.

One end of the single horn roll shaft 301 is designed as a stepped shaft. A shaft sleeve 201, a rolling bearing 202, a shaft collar 203, a bearing support 204, and a bearing end cover 205 are mounted on the stepped shaft. The parts on the stepped shaft are coaxially fitted. The position where the rolling bearing 202 is installed is the same as that of the connecting shaft 303 described below, and is designed as a node where the vibration is zero and which serves a function of supporting rigidity. A keyway 311 is provided at the end of the stepped shaft, which is connected to the universal coupling 7 via a key. A roll 312 is designed on the other side of the stepped shaft. The roll 312 is cylindrical, and its main function is to cause continuous plastic deformation of the high-precision ultra-thin strip.

The other end of the single horn roll shaft 301 is a longitudinal-torsional horn 313, which adopts a conical horn. The external shape is conical, and spiral grooves are provided on the conical surface. The length of the spiral grooves is the same as the length of the conical surface. The spiral direction is designed to be the same as the rotation direction of the horn roll shaft. A threaded rod 314 is provided at the large end of the conical surface. The connecting shaft 303 is entirely designed as a stepped shaft. The installation of parts on this shaft is the same as that on the stepped shaft at one end of the horn roll shaft, requiring coaxial assembly. An end surface for bolt pre-tightening is milled on the shaft body. The shaft shoulder position where the rolling bearing 202 is installed is still designed as a node. A threaded hole 315 at one end of the connecting shaft 303 engages with the threaded rod 314 at the large end of the conical surface of the longitudinal-torsional horn 313 via a threaded fit. A threaded hole 315 at the other end is coaxially fitted with multiple piezoelectric ceramics 304 and multiple copper electrodes 305. Piezoelectric ceramics 304 and copper electrodes 305 are required to be assembled concentrically and alternately one by one. The longitudinal polarization directions of every two adjacent piezoelectric ceramics 304 are opposite. After being cleaned, the piezoelectric ceramics 304 are bonded with a special adhesive and undergo an aging treatment. Furthermore, the rear cover plate 306 is concentrically assembled with the former. Finally, the hexagon socket head bolt 307 connects the connecting shaft 303, the piezoelectric ceramics 304, the copper electrodes 305, and the rear cover plate 306. During assembly, close contact between the piezoelectric ceramics 304, the copper electrodes 305, and the connecting shaft 303 must be ensured.

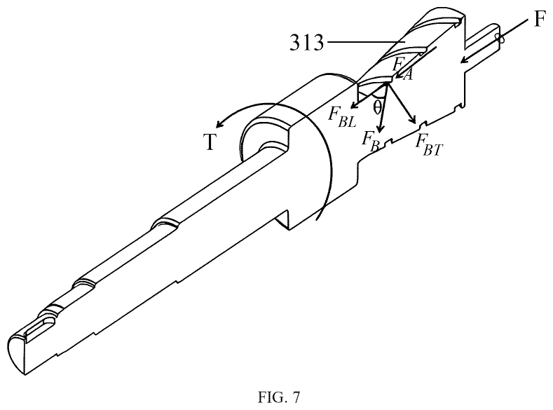

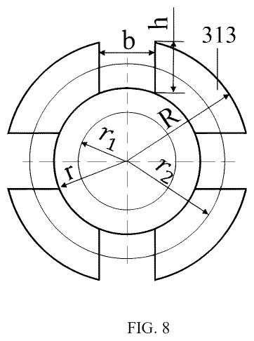

Horns are divided into two main categories according to their function: half-wavelength horns and quarter-wavelength horns. Compared with the half-wavelength horn, the quarter-wavelength horn has a compact structure, small size, light weight, and high energy conversion efficiency. The present disclosure adopts the quarter-wavelength horn. Common horn shapes include five types: stepped, conical, exponential, catenoidal, and Fourier-type. The present disclosure adopts the conical horn. The external shape is conical, and a threaded rod 314 is provided at the large end of the conical surface, which enables a threaded connection with the connecting shaft 303. The area of the ultrasonic input end (the large end of the conical surface) is larger than the area of the output end (the small end of the cone), aiming to concentrate the vibration energy onto a smaller area during ultrasonic propagation, serving an energy-gathering function. Spiral grooves are provided on the conical surface of the horn, and their spiral direction is the same as the rotation direction of the single horn roll shaft 301. During the rolling process, the ultrasonic longitudinal-torsional composite vibration may act on the precision ultra-thin strip more efficiently, reducing energy loss. The length of the spiral grooves is the same as the length of the conical surface. The longitudinal vibration generated by the radially polarized piezoelectric ceramic stack is partially converted into torsional vibration. As shown in FIG. 7 and FIG. 8, a spiral groove structure is designed on the conical section. The geometric structure of the conical section includes an external grooved part and an internal solid part. The force on any cross-section is also composed of these two parts, namely F=F_{A}+F_{B}, where the magnitudes of F_{A} and F_{B} are affected by the groove depth h, h=R−r, and

$${F}_{B} = \frac{( 2 Rh - {h}^{2} ) F}{{R}^{2}} .$$

It may be seen that F_{B} increases monotonically with the increase of the groove height h. The direction of the force F_{A} on the cross-section of the internal solid part remains unchanged, while the direction of the force F_{B} on the cross-section of the external grooved part changes along the groove direction, forming an angle θ with F. Furthermore, F_{B} may be decomposed into a longitudinal component F_{BL}=F_{B} cos(θ) and a tangential component F_{BT}=F_{B} sin(θ). Therefore, the longitudinal force on the cross-section is F_{L}=F_{A}+F_{B} cos(θ), and the tangential force is F_{T}=F_{B} sin(θ). The longitudinal force F_{L} generates the longitudinal vibration mode, while the tangential force F_{T} generates the torsional vibration mode. The torque on the cross-section is:

$$M = \frac{( 2 Rh - {h}^{2} ) F sin ( θ )}{{R}^{2}} [ r + R - \frac{{r}^{2} - rb}{b} \cdot ( ln \vert bR + {r}^{2} - rb \vert - ln \vert br + {r}^{2} - rb \vert ) ] .$$

In summary, the torque ultimately transmitted by the ultrasonic horn is related to factors such as the height h, width b, and spiral angle θ of the spiral grooves (the spiral angle in the present disclosure is 45 degrees, with four spiral grooves), as well as the conical surface radii R and r.

In a specific embodiment, the connecting shaft 303 is entirely designed as a stepped shaft, with threaded holes 315 provided at both ends, requiring coaxial constraint. One end is threadedly connected to the single horn roll shaft 301, and the threaded hole 315 at the other end is engaged with the hexagon socket head bolt 307. An end surface for bolt pre-tightening is milled on the shaft body, and a shaft shoulder is designed on the right side of this end surface. In addition to positioning the rolling bearing 202, this location is designed as a node. The vibration displacement at the node position is always zero, remaining stationary, which reduces the impact of ultrasonic longitudinal-torsional vibration on the roll shaft and also enables the generation of the maximum amplitude.

In a specific embodiment, the piezoelectric ceramics 304 optionally use polarized transmitting/receiving high-power piezoelectric ceramic materials with high electromechanical conversion efficiency and a high mechanical quality factor. A through hole is provided in the axial center of the piezoelectric ceramics 304, and the diameter of the through hole is the same as that of the threaded hole 315 at one end of the connecting shaft 303. The quantity is preferably an even number of pieces (the embodiment of the present disclosure uses six pieces of end-polarized piezoelectric ceramics 304). The longitudinal polarization directions of every two adjacent piezoelectric ceramics 304 are opposite. After cleaning, they are bonded with a special adhesive and undergo an aging treatment. The thickness of the piezoelectric ceramics 304 is an important factor affecting the vibration effect. If the thickness is too thin, vibration is easily generated after excitation, and energy loss will occur during ultrasonic propagation. If the thickness is too thick, vibration is not easily generated after excitation. Therefore, the rational selection of the thickness of the piezoelectric ceramics 304 is very important.

In a specific embodiment, a through hole is provided in the axial center of the copper electrodes 305. The diameter of the through hole is the same as that of the piezoelectric ceramics 304, and it is used for combination with the piezoelectric ceramics 304. The quantity of copper electrodes 305 is the same as the quantity of piezoelectric ceramics 304. High-frequency current is conducted to excite the piezoelectric ceramic elements to produce an electrostrictive effect. This effect causes the material to produce microscopic mechanical vibrations, which are then amplified by mechanical resonance to form macroscopic ultrasonic vibrations.

In a specific embodiment, the rear cover plate 306 is provided to prevent energy generated by the piezoelectric ceramic stack from radiating out through the hexagon socket head bolt 307, which would cause significant energy loss, and also to assist in dissipating heat from the piezoelectric ceramics 304. A through hole is provided at the axial center of the rear cover plate 306, and the diameter of the through hole is the same as that of the through holes in the piezoelectric ceramics 304 and the copper electrodes 305. These three components are tightly fitted with the hexagon socket head bolt 307 coaxially.

In a specific embodiment, the hexagon socket head bolt 307 clamps the piezoelectric ceramics 304 and the copper electrodes 305 between the rear cover plate 306 and the connecting shaft 303 through pre-tightening, while also applying a certain pre-stress to the piezoelectric ceramics 304. The purpose is to reduce the vibration tension and resonant frequency between the connecting shaft 303 and the piezoelectric ceramics 304, the copper electrodes 305, and the rear cover plate 306, increase their mechanical strength, and prevent fatigue fracture of the piezoelectric ceramics 304.

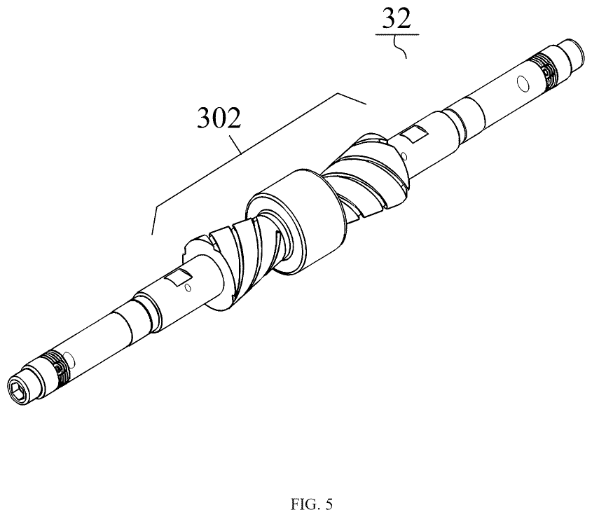

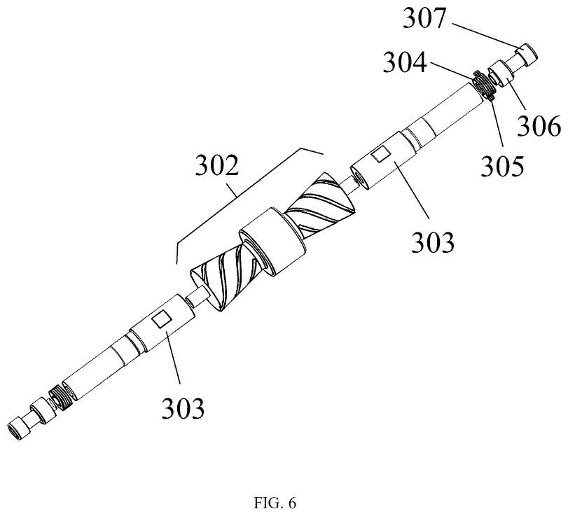

In another specific embodiment, the ultrasonic longitudinal-torsional vibration device 3 adopts a dual-excitation ultrasonic longitudinal-torsional vibration device 32. As shown in FIG. 5 and FIG. 6, the dual-excitation ultrasonic longitudinal-torsional vibration device 32 includes a dual horn roll shaft 302, two connecting shafts 303, multiple piezoelectric ceramics 304, multiple copper electrodes 305, two rear cover plates 306, and hexagon socket head bolts 307. Except for the dual horn roll shaft 302, the design, principles, and functions of the other components are the same as those of the previously described single-excitation ultrasonic longitudinal-torsional vibration device 31. The dual horn roll shaft 302 mainly includes a roll 312 and dual horns. The design of the roll 312 is the same as described previously. The difference in the horn part is that two longitudinal-torsional horns 313 are symmetrically designed. The spiral grooves of these two horns have opposite spiral directions. The purpose of this design is that during the rotation and operation of the apparatus driven by the rolling mill drive mechanism 6, the rotation direction of the ultrasonic longitudinal-torsional vibration of the dual horns remains the same as that of the former device, thereby reducing energy loss, minimizing heat generation, and improving processing efficiency.

Compared with the prior art, the present disclosure discloses at least the following beneficial effects.

The present disclosure proposes a composite processing technique that combines the ultrasonic vibration energy field with precision ultra-thin strip rolling, which may solve problems encountered in the conventional ultra-thin strip rolling process.

The ultrasonic longitudinal-torsional vibration rolling device designed in the present disclosure may generate torsional vibration along the direction of the spiral grooves and vibration along the axial direction of the horn, thereby achieving longitudinal-torsional coupled ultrasonic vibration of the roll tool head. Compared with a single longitudinal ultrasonic vibration design, this design is more integrated and compact, reduces the loss of ultrasonic energy during transmission, avoids the occurrence of heating phenomena, achieves high processing precision, and is reasonably designed.

The spiral groove structure designed on the conical horn section in the present disclosure may be adapted to the required longitudinal-torsional vibration amplitudes in different production scenarios by reasonably changing factors such as the height h, width b, and spiral angle θ of the spiral grooves, and the conical surface radii R and r.

The dual-excitation ultrasonic longitudinal-torsional vibration device designed in the present disclosure symmetrically arranges two sets of longitudinal-torsional horns with opposite spiral groove directions on both sides of the roll tool head. The two sets of horns cooperatively output torsional vibration, which may significantly increase the torsional ultrasonic vibration amplitude in the circumferential direction of the roll.

In the description of the present disclosure, it is to be understood that the orientation or positional relationships indicated by the terms “longitudinal”, “transverse”, “upper”, “lower”, “front”, “rear”, “left”, “right”, “vertical”, “horizontal”, “top”, “bottom”, “inner”, “outer”, etc., are based on the orientation or positional relationships shown in the accompanying drawings. These terms are used only for the convenience of describing the present disclosure and do not indicate or imply that the referred apparatus or element must have a specific orientation or be constructed and operated in a specific orientation. Therefore, these terms are not to be construed as limiting the present disclosure.

The embodiments described above are only for describing the optional modes of the present disclosure, and are not intended to limit the scope of the present disclosure. Various deformations and improvements to the technical solutions of the present disclosure made by those of ordinary skill in the art without departing from the design spirit of the present disclosure shall fall within the protection scope defined by the claims of the present disclosure.

What is claimed is:

1. A two-roll rolling apparatus for ultrasonic-assisted longitudinal-torsional composite vibration, comprising:
a rolling mill frame mounted on a rolling mill body;
an ultrasonic longitudinal-torsional vibration device installed inside the rolling mill frame, for connecting an ultrasonic generating device and a roll shaft of a rolling mill, wherein the ultrasonic longitudinal-torsional vibration device comprises a horn roll shaft, a connecting shaft, piezoelectric ceramics, copper electrodes, a rear cover plate, and a hexagon socket head bolt; a stepped shaft is provided at one end of the horn roll shaft, and another end is connected to a longitudinal-torsional horn; the longitudinal-torsional horn is a conical horn, a conical surface of the longitudinal-torsional horn is provided with spiral grooves, a length of the spiral grooves is equal to a length of the conical surface, and a spiral direction of the spiral grooves is same as a rotation direction of the horn roll shaft; and a number of the piezoelectric ceramics is even, longitudinal polarization directions of every two adjacent of the piezoelectric ceramics are opposite, and the piezoelectric ceramics are bonded by an adhesive to form a piezoelectric ceramic stack; and
a winding device, an auxiliary winding device, and an unwinding device arranged on two sides of the rolling mill, for providing a strip to be rolled, guiding transmission of the strip, and coiling a rolled strip into a coil;
wherein the connecting shaft is a stepped shaft, one end of the connecting shaft is threadedly connected to the longitudinal-torsional horn, and another end is coaxially assembled with the piezoelectric ceramics and the copper electrodes alternately stacked and is pre-fastened with the rear cover plate by the hexagon socket head bolt; and an end surface is milled on a shaft body of the connecting shaft for bolt pre-fastening, a shaft shoulder is provided on a right side of the end surface, the shaft shoulder is designed as a node, and a vibration displacement at the node remains zero.

2. The two-roll rolling apparatus for ultrasonic-assisted longitudinal-torsional composite vibration according to claim 1, wherein the ultrasonic longitudinal-torsional vibration device is a single-excitation ultrasonic longitudinal-torsional vibration device or a dual-excitation ultrasonic longitudinal-torsional vibration device.

3. The two-roll rolling apparatus for ultrasonic-assisted longitudinal-torsional composite vibration according to claim 2, wherein the single-excitation ultrasonic longitudinal-torsional vibration device comprises a single horn roll shaft, wherein the single horn roll shaft is designed as the stepped shaft at one end of the single horn roll shaft and as the longitudinal-torsional horn at another end of the single horn roll shaft; and the longitudinal-torsional horn is a quarter-wavelength horn, and an input end area of the longitudinal-torsional horn is larger than an output end area for achieving energy concentration.

4. The two-roll rolling apparatus for ultrasonic-assisted longitudinal-torsional composite vibration according to claim 2, wherein the dual-excitation ultrasonic longitudinal-torsional vibration device comprises a dual horn roll shaft, wherein the dual horn roll shaft comprises two longitudinal-torsional horns symmetrically arranged, the spiral grooves of the two longitudinal-torsional horns have opposite spiral directions for cooperatively increasing a torsional vibration amplitude.

5. The two-roll rolling apparatus for ultrasonic-assisted longitudinal-torsional composite vibration according to claim 1, wherein a height (h), a width (b), and a spiral angle (0) of the spiral grooves, and conical surface radii (R) and (r) are adjusted according to production requirements, for achieving different longitudinal-torsional vibration amplitudes.

6. The two-roll rolling apparatus for ultrasonic-assisted longitudinal-torsional composite vibration according to claim 5, wherein the spiral angle of the spiral grooves is 45 degrees, a number of the spiral grooves is four, and the spiral grooves are uniformly provided along the conical surface.

7. The two-roll rolling apparatus for ultrasonic-assisted longitudinal-torsional composite vibration according to claim 1, wherein a pressing-down device is installed above the rolling mill frame, and a supporting mechanism is installed on a side surface of the rolling mill frame.

8. The two-roll rolling apparatus for ultrasonic-assisted longitudinal-torsional composite vibration according to claim 1, further comprising a controller and an electrical cabinet provided on the rolling mill body, wherein the controller is configured for tension control and parameter adjustment, and the electrical cabinet is configured to provide power supply.
